(19) United States
(12) Patent Application Publication
(10) Pub. No.: US 2015/0165446 A1
(43) Pub. Date: Jun. 18, 2015

(54) Apparatus

(71) Applicant: PANEL BOARD HOLDING BV, Niederlande (NL)

(72) Inventors: Pat Barry, Genk (BE); Rony Callens, Niort (FR); Eric Schroeder, Athus (BE)

(73) Assignee: PANEL BOARD HOLDING BV, The Hague (NL)

(21) Appl. No.: 14/414,464

(22) PCT Filed: Jul. 19, 2013
(86) PCT No.: PCT/EP2013/065267

§ 371 Date: Jan. 13, 2015

(30) Foreign Application Priority Data
Jul. 23, 2012 (EP) 12177485.5
Aug. 29, 2012 (EP) 12182187.0

(51) Int. Cl. B02C 23/26; B02C 23/30; B02C 13/288

(52) U.S. Cl. CPC B02C 23/26; B02C 13/288; B02C 23/30

(57) ABSTRACT

The invention concerns an apparatus, especially an air flow system, especially to reduce size of material, particularly of light material, preferably raw materials for panels.

### FIELD OF THE INVENTION

The invention concerns an apparatus, especially an air flow system, especially to reduce size of material, particularly of light material, preferably raw materials for panels.

### BACKGROUND OF THE INVENTION

An apparatus to reduce size of material typically transforms material, material pieces and/or material chips in flakes and/or fibers. Examples of such apparatuses include knife ring flakers, hammer mills, refiners or defibrators. These types of said apparatus all comprise a supply unit and a size reduction unit. Materials for processing like for example pieces of wood, plants, non-woody lignocelluloses and/or recycling materials such as polymer, packaging fabrics, paper and cardboard waste are inserted in the supply unit. Typically, the material is directly supplied from the supply unit to the size reduction unit. The size reduction unit comprises means to reduce the size of the material through cutting, shredding or grinding. In said machines, the size reduction unit is mainly of the type of a knife ring where the material is carried in a rotating impeller and pushed to the blades of a fixed ring with blades under the influence of centrifugal force. Typically, the feed system of said machines is driven by gravity force of the material. Therefore, particularly light material may often lead to problems such as reduced throughput or clogging in the size reduction unit. Examples for said light material include light wooden chips or flakes, straw, flax, corn, grass, rice stalks, leaves, bamboo, shrubs, algae, seaweed and recycling material such as polymer films, protective packaging fabrics, solve packaging, paper and cardboard waste.

DE 02702338 A1 discloses an apparatus of the type of a knife ring flaker to reduce size of material with a blade ring around a rotor characterized by a radial fan to reduce the problem of material clogging at the blades by means of a cyclic air flow between knife ring and housing. An air flow supports the transportation of materials.

### SUMMARY OF THE INVENTION

The present invention is set forth and characterized in the independent claims, while the dependent claims describe other characteristics of the invention

The purpose of the invention is to achieve an improved apparatus for size reduction of material, particularly of light material, preferably raw materials for panels.

The device according to the invention comprises an apparatus to reduce size of material, particularly of light material, with a material supply unit and a size reduction unit as well as a suction unit for sucking material, particularly light material, through the size reduction unit.

Suction unit means a unit to generate depression, for example with a fan. In the presence of gas, said depression enables a gas flow to the suction unit. Sucking of material by said suction unit means that a gas, for example air, transfers forces to the pieces and/or particles of said material, so that the material can move and follow the direction of said gas flow to the suction unit.

The sucking of the material, particularly light material, through the size reduction unit by a suction unit enables high material throughput and little clogging in an improved manner especially compared with other gas flow techniques in order to transport materials through a size reduction unit. In addition, by overcoming the problem of clogging of particularly light material, the invention allows processing of material that otherwise could not or only under great difficulties be processed.

One favorable embodiment of the invention comprises a gas source connected with the entrance of the size reduction unit and/or with the outlet of the size reduction unit.

A gas source is a defined access to gas. A defined access is an access designed to supply gas to the apparatus. A defined access does not mean areas where by some reason gas may be sucked into the apparatus for example leaky pipes or connection as well as connected units such as the supply unit where gas may enter the apparatus through the material or when the supply unit runs out of material. A simple example for a gas source could be an open end of a pipe leading to the environmental air. A complex example for a gas source could be a chamber with gas supply and/or a conditioning unit to condition the gas.

Connecting the gas source with the entrance of the size reduction unit enables feeding with high feed rates of the material into the size reduction unit and also treating the material with conditioned gas from the gas source prior to the size reduction process. Connecting the gas source with the outlet of the size reduction unit leads to reduced clogging in the size reduction unit and also allows treating the size reduced material with conditioned gas from the gas source. The combination of both said connections brings both described advantages.

One favorable embodiment of the invention comprises one or more flow channels for guiding a gas flow and/or material flow. Flow channels can connect to other flow channels or units, i.e. gas source or sucking unit, in a sealed manner. The cross-sectional shape of a flow channel can be a polygon or round shape for example a rectangle or a cycle. A flow channel can also branch off other flow channels. Said flow channels for guiding a gas flow and/or material flow enable the targeted transport of material, particularly driven by the suction unit.

One preferred embodiment comprises for example a flow channel starting from the gas source, taking up a branch flow channel from the material supply unit, branch off a flow channel or chamber for a separation unit and connecting to entrance of the size reduction unit as well as another flow channel starting from the gas source, taking up a branch flow channel from the outlet of the size reduction unit and connecting to the suction unit.

One preferred embodiment of the invention comprises a gas source connected to the entrance of the size reduction unit by a flow channel running above the size reduction unit. This flow channel arrangement enables gravity force to support the material flow to the size reduction unit.

One favorable embodiment of the invention comprises a supply unit placed above the size reduction unit, preferably connected to the vertical part of the flow channel leading to the entrance of the size reduction unit, particularly with a connection in form of a down slope flow channel. Arranging the material supply unit in the described way has the advantages, that gravity force supports the suction unit with the material transport, thus reducing energy consumption. The connection of a flow channel to another flow channel, particularly vertical downwards oriented flow channel, enables an additional sucking effect that improves the material flow from the material supply unit. A down slope flow channel for connection of the material supply unit with another flow channel as the advantage, that heavy impurities or material pieces are moving on the bottom of the flow channel instead of simply falling down as it would be the case in a vertical flow channel.

One favorable embodiment of the invention comprises a separation unit for separating heavy impurities in the material, particularly in form of a branched off chamber, preferably branched off in a curve and/or in the direction of gravity forces, particularly branched off from a flow channel for guiding a gas and material flow to the entrance of the size reduction unit.

One favorable embodiment of the invention comprises a separation unit for separating heavy impurities in the material. Said separation unit removes impurities that would otherwise impurify the processed material and could damage the size reduction unit. A separation unit arranged as branched off chamber is a very simple way of realizing such separation unit. Branching off such chamber in a curve and/or in the direction of gravity forces bring the advantage that heavy impurities can be separated in the chamber due to their difference in weight, thus no complex separation devices are needed. Said separation unit can be particularly branched off from a flow channel for guiding a gas and material flow to the entrance of the size reduction unit to assure that all material for processing in the size reduction unit passes the separation unit. Thanks to such integrated separation unit, there is not need for an additional work step for separation prior to the processing in the apparatus to reduce size of material.

One preferred embodiment of the invention comprises a separation unit with means for removal of separated heavy impurities by an operator for example through a removal flap. Means for removal of the separated impurities by an operator can be realized very simple and have the advantage of being very flexible and reliable compared to complex automated solutions. For example a simple removal flap can be used.

One preferred embodiment of the invention comprises a size reduction unit, particularly comprising a knife ring, arranged in a way that the entrance of the size reduction unit is oriented horizontally and/or away from the gas source and/or the outlet of the size reduction unit is oriented vertically and/or downward. The described orientation of the entrance and outlet of the size reduction unit helps to reduce the space needed to arrange the material supply unit and separation unit while taking advantage of gravity forces to support the material transport, thus allowing the design of a smaller dimensioned apparatus

One favorable embodiment of the invention comprises a outlet of the size reduction unit and/or of the connected flow channel with a cross-section area smaller than the cross-section area of the entrance of the size reduction unit and/or of the connected flow channel to the suction unit, particularly connected in form of a T-shape, preferably connected to a flow channel running from the gas source to the suction unit. The difference in said cross-section areas enables an improved gas and material flow through the size reduction unit and thereby boosts the favorable effects of the innovation. Same benefits arise when connecting the outlet of the size reduction unit or a flow channel connected to the outlet of the size reduction unit with a flow channel that connect the gas source with the suction unit, for example with a T-shaped connection. Because the gas flow in said flow channel leads to additional suction force at the outlet of the size reduction unit and thereby improves the suction of material through the size reduction unit.

One favorable embodiment of the invention comprises a suction unit with a greater cross-section area compared to the entrance of the suction unit and/or with means for separating gas and material. The greater cross-section area within the suction unit compared to the entrance of the suction unit allows the implementation of a suction driver, for example fan, adapted to the material that shall be processed in the apparatus without imposing close restrictions for the dimensions of said suction driver. Furthermore, said cross-section area different leads to improved flow characteristics of the gas and/or material for separating gas and material in the suction unit. Said separation of gas and material in the suction unit brings the advantages that small particles or additives, which were added to the gas, can be extracted for environmentally safe removal or recycling, thus eliminating the release of harmful particles and dusk to the environment and thereby increase operating safety or obviating the need for additional particle and/or dusk sucking devices.

One favorable embodiment of the invention comprises a distributer for distributing a gas flow in two or more separated gas flows. Distribution of a gas flow in separated gas flows means that the gas flow of the supplying flow channel is distributed in branch flow channels in a way that the flow rate in each channel can be adjusted. A simple way of implementing said distributer is to place a turnable flap particularly inside of the supply flow channel with for example the pivot bearing positioned in the center point of a Y-, T- or t-shaped duct branch. Seen from the pivot gearing, the flap can be placed in or against the direction of the gas flow. The advantage of said distributer is that the process outcome of the apparatus can be improved by adapting the flow rate in each flow channel to the processed material.

One favorable embodiment of the invention comprises a gas source comprises a gas inlet with a mesh or filter and/or an outlet with distributer, preferably with a cross-section area of the outlet smaller than the cross-section area of the inlet of said gas source. Intake of material or dusk is avoided by mesh or filter at the inlet of the gas source that otherwise would impurify the processed material.

Particularly for a gas source with integrated hazardous conditioning unit such as a heat exchanger, a mesh also increases operating safety. The distributer at the outlet allows adaption of the flow rates in the supplied flow channels to the currently processed material to improve process outcome. A gas source with greater cross-section area of inlet than of the outlet brings the advantage of reduced flow rate at the inlet, thus improving operational safety as well as increased efficiency for favorable embodiments with integrated heat exchangers.

In another aspect of the invention, an apparatus to reduce size of material, particularly of light material, with a material supply unit and a size reduction unit comprises a conditioning unit for treatment of material before and/or after size reduction preferably by means of conditioned gas. The advantage of the invention is that additional working steps prior or after the working step of size reduction are obviated. Preferably conditioned gas, meaning gas conditioned by the conditioning unit, can be used for said material treatment in order to achieve homogeneous treatment of the entire material surface.

One favorable embodiment of the invention comprises a conditioning unit that allows adjusting the gas temperature and/or adding additives to the gas, particularly liquids, other gases, and/or powders. Adjusting the gas temperature enables to improve the process. High gas temperature leads for example to dry material pieces that typically reveal reduced clogging. Adding additives enables various beneficial effects to the size reduction process, the operating safety and the characteristics of the treated material. There are for example additives that increase fire resistance and thereby improved operating safety. Additives in form of for example powers can particularly reduce clogging. Other additives such as for example disinfectants, perfumes, colorants, neutralizers and antioxidants as well as waterproof, anti-aging and anti-rot agents enable value addition to the material without additional, subsequent process steps.

Furthermore, addition of other gases or liquids enables to adjust the humidity of the gas leading to wetting or drying the material.

One favorable embodiment of the invention comprises an injector for adding additives particularly to gas for example within the gas source, preferably arranged with a nozzle shaped injector particularly placed in the middle area of a chamber or flow channel for guiding a gas flow and/or directed towards the outlet of said chamber or flow channel. Nozzle shape means that the cross-section area of the injector opening is narrowing down from a wide to a smaller cross-section area in the direction of the flow of additives. The described placement and orientation of said injector enables favorable distribution of the additives in the gas flow.

One favorable embodiment of the invention comprises a an additives supply unit for supplying additives to the injector preferably in the shape of a funnel, particularly placed above the injector and/or outside of a chamber or flow channel, and preferably connected to the injector with a L-shaped supply channel. The described additives supply unit with connection to the injector is a very simple but reliable way of supplying the injector with additives while offering an easy access for the operator to refill additives.

One favorable embodiment of the invention comprises a heat exchanger for cooling and/or heating gas, preferably placed directly in a chamber or flow channel for containing or guiding a gas flow, particularly at the gas inlet of the gas source. A heat exchanger of such kind and arranged in the proposed manner is a simple and effective way to heat up or cool down gas.

One favorable embodiment of the device according to the invention comprises an improved apparatus with a size reduction unit comprising a knife ring and impeller for example as used in a knife ring flaker.

The features described in the main, dependent and independent claims can be implemented in an apparatus with a size reduction unit comprising a knife ring and impeller very easily while delivering the described advantages of the innovation particularly well.

One favorable embodiment of the invention comprises an outlet of the size reduction unit that is connected to a flow channel to the suction unit, particularly connected in form of a T-shape, preferably connected to a flow channel running from the gas source to the suction unit. Improved gas and material flow through the size reduction unit can be obtained when connecting the outlet of the size reduction unit to a flow channel that connects the gas source with the suction unit, for example with a T-shaped connection. Because the gas flow in said flow channel leads to additional suction force at the outlet of the size reduction unit and thereby improves the suction of material through the size reduction unit.

One favorable embodiment of the invention comprises a distributer for distributing a gas flow in two or more separated gas flows, preferably by means of a turnable flap and/or separation wall. Seen from the gas source, the separation wall can be placed behind the turnable flap, connected via pivot bearing, in the direction of the gas flow to separate the outgoing flow cannels in order to achieve improved aerodynamics of the gas flow during and after passing the distributer.

The apparatus according to the invention, especially an air flow system, can also include other units for material processing other than for example a size reduction unit, such as a blending unit, a separation unit, a sensor unit or a further conditioning unit.

### BRIEF DESCRIPTION OF THE DRAWINGS

These and other characteristics of the invention will be clear from the following description of a preferential form of embodiment, given as a non-restrictive example, with reference to the attached drawings wherein:

FIG. 1 shows an apparatus to reduce size of material according to the invention with a size reduction unit comprising a knife ring.

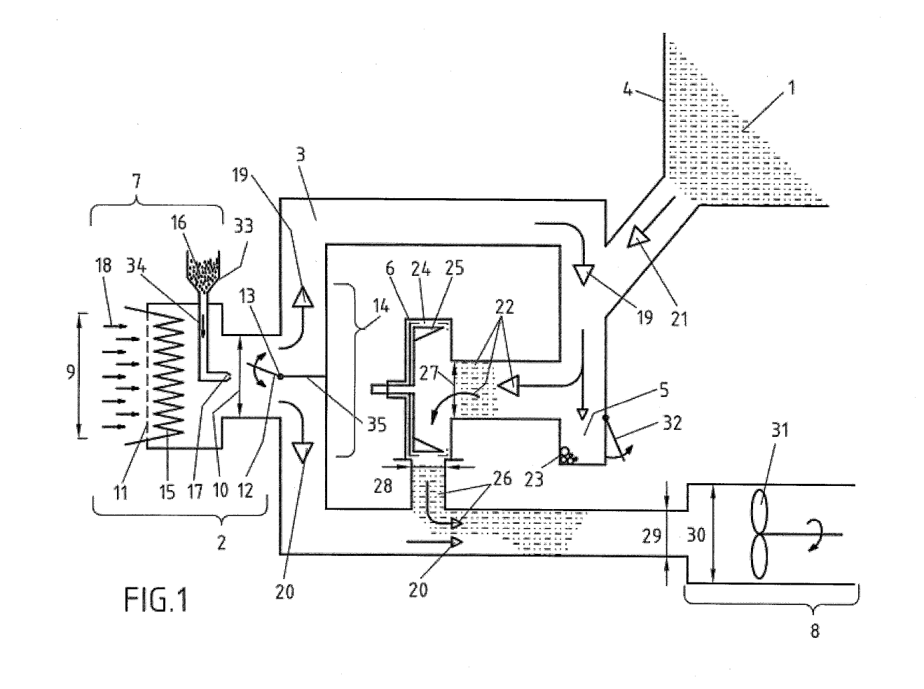

### DETAILED DESCRIPTION OF A PREFERENTIAL EMBODIMENT

With reference to the attached drawing, an apparatus to reduce size of material 1, particularly light material, comprises a gas source 2, flow channels 3 for guiding a gas flow and/or material flow between connected units or other flow channels, a material supply unit 4, a separation unit 5, a size reduction unit 6, a conditioning unit 7 and a suction unit 8.

The suction unit 8 causes depression and thereby drives a gas flow consisting of environmental air 18 and originating at the gas source 2 with integrated conditioning unit 7.

The gas source 2 comprises a chamber with an inlet to allow environment air 18 from outside the apparatus to enter into the chamber. In order to reduce the incoming flow rate of the environment air 18, the cross-section area of the inlet 9 of said gas source 2 is designed greater than the cross-section area of the outlet 10. The cross-section area of the inlet 9 is covered by a mesh 11. At the outlet of said gas source 2, a turnable flap 12 with pivot bearing 13 placed in the center point of a T-shaped duct branch 14 works as distributer to distribute the gas flow at the outlet of the gas source 2 to the two branched off flow channels 3 and to adjust the gas flow rate in each flow channel.

The conditioning unit 7 for adjusting the temperature and adding additives to the gas 2 is integrated in the gas source 2. A heat exchanger 15 is placed inside of the chamber of the gas source 2 directly behind the mesh 11 and running over the entire cross-section area of the inlet 9 of the gas source 2. Additives 16 including liquids or powders are supplied from outside the chamber of the gas source 2 to a nozzle shaped injector 17 in the center the gas flow in said chamber by an additives supply unit with a funnel (33) and L-shaped supply channel 34.

At the outlet of the gas source 2, said distributer distributes the gas flow from the gas source 2 into two separated gas flows 19, 20.

One gas flow 19 is guided by means of flow channels 3 from the gas source 2 above the size reduction unit 6 to the intersection with the material flow 21 from the material supply unit 4 that is connected through a down sloped branch flow channel. The depression in that flow channel, the passing gas flow 19 and the gravity forces all facilitate the material flow 21 of the material 1 into the flow channel 3 with the gas flow 19.

After that intersection, the gas flow 19′ and the material flow 21 combined to one gas material flow 22. A curve of the flow channel 3 between said intersection and the entrance of the size reduction unit 6 caused the gas material flow 22 to follow that curve. Heavy impurities 23 are diverted into the branched off separation unit 5 in direction of and due to gravity forces and can be removed through a flap 32.

After passing the separation unit 5, the gas material flow 22 runs through the size reduction unit 6 comprising a knife ring 24 and a rotating impeller 25 for pressing the material against the blades of the knife ring 24 in order to facilitate size reduction of the material.

After the gas material flow 22 passed the size reduction unit 6, the gas flow with size reduced material 26 run into the gas flow 20 at a T-shape intersection of the respective flow channels 3. The cross-section area of the outlet of the size reduction unit 28, which is equal to the connected flow channel 3, is smaller than the cross-section area of the entrance of the size reduction unit 27 and the cross-section area of the connected flow channel to the entrance of the suction unit 29. The difference in said cross-section areas enables an improved gas material flow through the size reduction unit with increased suction force as well as improved material distribution in the gas flow with size reduced material heading the suction unit 8 for improved separation of gas and material in the suction unit 8.

The suction unit cross-section area 30 is again greater than the cross-section areas of the entrance of the suction unit 29 to enable usage of bigger dimensioned fans 31.

At the outlet of the gas source 2, the pivot bearing 13 connects the turnable flap 12 to a separation wall 35.

It is obvious however that modifications and/or additions can be made to the apparatus as described heretofore, but these shall remain within the field and scope of the invention. For example, the size reduction unit can have different components from those shown and described here or the conditioning unit can be replaced by another, functionally equivalent element.

1-15. (canceled)

16. An apparatus, especially an air flow system, especially to reduce size of material, preferably raw materials for panels, comprising a material supply unit (4) and a unit, preferably size reduction unit (6), characterized by a suction unit (8) for sucking material (1), particularly light material, through the unit, preferably size reduction unit (6).

17. The apparatus of claim 16, characterized by a gas source (2) connected with the entrance of the unit, preferably size reduction unit (6), and/or with the outlet of the unit, preferably size reduction unit (6).

18. The apparatus of claim 17, further comprising at least one flow channel (3) for guiding a gas flow and/or material flow.

19. The apparatus of claim 16, characterized in that the material supply unit (4) is placed above the unit, preferably size reduction unit (6), preferably connected to the vertical part of the flow channel (3) leading to the entrance of the unit, preferably size reduction unit (6), particularly with a connection in form of a down slope flow channel.

20. The apparatus of claim 16, characterized in that the material supply unit (4) is placed above the unit, preferably size reduction unit (6), preferably connected to the vertical part of the flow channel (3) leading to the entrance of the unit, preferably size reduction unit (6), particularly with a connection in form of a down slope flow channel.

21. The apparatus of claim 16, further comprising a separation unit (5) for separating heavy impurities (23) in the material (1), particularly in form of a branched off chamber, preferably branched off in a curve and/or in the direction of gravity forces, particularly branched off from a flow channel (3) for guiding a gas and material flow to the entrance of the unit, preferably size reduction unit (6).

22. The apparatus of claim 17, further comprising a separation unit (5) for separating heavy impurities (23) in the material (1), particularly in form of a branched off chamber, preferably branched off in a curve and/or in the direction of gravity forces, particularly branched off from a flow channel (3) for guiding a gas and material flow to the entrance of the unit, preferably size reduction unit (6).

23. The apparatus of claim 16, characterized in that the outlet of the unit, preferably size reduction unit (6), is connected to a flow channel to the suction unit, particularly connected in form of a T-shape, preferably connected to a flow channel running from the gas source (2) to the suction unit (8).

24. The apparatus of claim 17, characterized in that the outlet of the unit, preferably size reduction unit (6), is connected to a flow channel to the suction unit, particularly connected in form of a T-shape, preferably connected to a flow channel running from the gas source (2) to the suction unit (8).

25. The apparatus of claim 16, further comprising a suction unit (8) with a greater cross-section area (30) compared to the entrance of the suction unit (29) and/or with means for separating gas and material.

26. The apparatus of claim 17, further comprising a suction unit (8) with a greater cross-section area (30) compared to the entrance of the suction unit (29) and/or with means for separating gas and material.

27. The apparatus of claim 16, further comprising a distributer for distributing a gas flow in two or more separated gas flows (19, 20), preferably by means of a turnable flap (12) and/or separation wall (35), particularly inside of a flow channel with for example the pivot bearing (19) placed in the center point of a Y-, T- or t-shaped duct branch (14).

28. The apparatus of claim 17, further comprising a distributer for distributing a gas flow in two or more separated gas flows (19, 20), preferably by means of a turnable flap (12) and/or separation wall (35), particularly inside of a flow channel with for example the pivot bearing (19) placed in the center point of a Y-, T- or t-shaped duct branch (14).

29. The apparatus of claim 16, characterized in that the gas source (2) comprises a gas inlet with a mesh (11) or filter and/or an outlet with distributer, preferably with a cross-section area of the outlet (10) smaller than the cross-section area of the inlet (9) of said gas source (2).

30. The apparatus of claim 16, wherein the size reduction unit (6), is characterized by a conditioning unit (7) for treatment of material before and/or after size reduction preferably by means of conditioned gas.

31. The apparatus of claim 30, characterized in that said conditioning unit (7) allows adjusting the gas temperature and/or adding additives (16) to the gas, particularly liquids, other gases, and/or powders.

32. The apparatus of claim 31, further comprising an injector (17) for adding additives (16) particularly to gas for example within the gas source (2), preferably arranged with a nozzle shaped injector (17) particularly placed in the middle area of a chamber or flow channel for guiding a gas flow and/or directed towards the outlet of said chamber or flow channel.

33. The apparatus of claim 32, further comprising an additives supply unit for supplying additives to the injector (17) preferably in the shape of a funnel (33), particularly placed above the injector (17) and/or outside of a chamber or flow channel, and preferably connected to the injector (17) with a L-shaped supply channel (34).

34. The apparatus of claim 30, further comprising a heat exchanger (15) for cooling and/or heating gas, preferably placed directly in a chamber or flow channel for containing or guiding a gas flow, particularly at the gas inlet of the gas source (2).

35. The apparatus of claim 30, further comprising a unit, preferably a size reduction unit (6), comprising a knife ring (24) and impeller (25).
